(19) United States
(12) Patent Application Publication
(10) Pub. No.: US 2021/0162325 A1
(43) Pub. Date: Jun. 3, 2021

(54) SEPARATOR FOR WASTEWATER TREATMENT WITH MOVABLE STRAINER ELEMENT

(71) Applicant: VOGELSANG GMBH & CO. KG, Essen (DE)

(72) Inventor: Paul Krampe, Essen (DE)

(73) Assignee: VOGELSANG GMBH & CO. KG, Essen (DE)

(21) Appl. No.: 17/263,952

(22) PCT Filed: Jul. 31, 2019
(86) PCT No.: PCT/EP2019/070630

§ 371 Date: Jan. 28, 2021

(30) Foreign Application Priority Data
Jul. 31, 2018 (DE) 20 2018 104 413.3

(51) Int. Cl. B01D 33/68; C02F 1/00; B01D 33/11; B01D 33/48; B01D 33/52; B01D 33/80; B01D 33/74; B01D 33/76

(52) U.S. Cl. CPC B01D 33/68; C02F 1/004; B01D 33/11; B01D 33/48; B01D 33/52; B01D 2201/325; B01D 33/74; B01D 33/76; C02F 2303/24; B01D 2201/02; B01D 33/801

(57) ABSTRACT

A separator device for separating fibrous material from wastewater has a housing comprising at least one inlet for wastewater, at least one first outlet for filtrate, at least one second outlet for the fibrous material, and least one hollow strainer element disposed in the housing, the inlet opening into the interior of the strainer element and the first outlet being disposed in an intermediate space between the housing and the strainer element. At least one strainer element of the separator device is movably disposed in the housing and coupled to a drive for displacing the strainer element. The invention further relates to a method for separating fibrous material from wastewater.

### CROSS-REFERENCE TO FOREIGN PRIORITY APPLICATION

The present application claims the benefit under 35 U.S.C. §§ 119(b), 119(e), 120, and/or 365(c) of PCT/EP2019/070630 filed Jul. 31, 2019, which claims priority to German Application No. 20 2018 104 413.3 filed Jul. 31, 2018.

### FIELD OF THE INVENTION

The invention relates to a separator device for separating fibrous material from wastewater, having a housing comprising at least one inlet for wastewater, at least one first outlet for filtrate, and at least one second outlet for the fibrous material, and having at least one hollow strainer element disposed in the housing, the inlet opening into the interior of the strainer element and the first outlet being disposed in an intermediate space between the housing and the strainer element. The invention further relates to a method for separating fibrous material from wastewater, preferably using a separator device of the type indicted above.

### BACKGROUND OF THE INVENTION

Separator devices of the type indicated above are used for filtering wastewater, such as wastewater from sewage treatment plants, but also liquid manure. One problem that arises thereby is that the strainer element quickly becomes blocked by the fibrous material and must therefore be backflushed. The fibrous material should then be removed during or after the filtration process. But the more the fibrous material can be dehydrated, the greater the accumulation of nutrients, and the filter cake or sludge should therefore be extensively dehydrated.

A separator device is known from DE 27 577 46, for example, wherein a cylindrical strainer element is oriented substantially horizontally and liquid can pass through the strainer element radially from the exterior to the interior. In order to achieve backflushing, wings are provided in the interior of the strainer element and tightly guided along the inner surface thereof in order to bring about a liquid impulse through the wall of the strainer element, so that fibrous material is separated from the same.

DE 690 03 110 T2 discloses a vertically oriented separator having two strainer elements placed concentrically one inside the other. A foil is disposed between said inner and outer strainer elements and rotates and travels along between said elements in order to bring about an impulse in turn and thus to achieve backflushing. The foils are substantially implemented as wings.

A separator modified with respect to the above is disclosed by WO 2002 26348 A1. The separator disclosed therein comprises a stationary and substantially cylindrical strainer element. The strainer element is placed in a housing. An opening opens into the strainer element from above. An outlet for the fibrous material is disposed at the bottom end of the strainer element and an outlet for the filtrate is disposed radially to the strainer element. A drive is provided for moving a barrel-shaped body within the strainer element in order to press the fibrous material against a radially internal surface of the strainer element. Backflushing, however, takes place here at best indirectly, and the strainer element cannot be prevented from becoming blocked over the long term.

Two separators are known from WO 2011 002317 A1 and WO 2016 009357 A1 and are oriented horizontally. A screw or displacement element is disposed in the interior of the strainer element and can transport liquid horizontally while pressing fibrous material against the radially internal surface of the strainer element in order to reduce the water content. Thus for said devices, the fibers are separated out of the liquid by means of a press screw in a first step in order to then filter out smaller particles in a second step.

In addition to such separators working with substantially cylindrical strainer elements, there also exist separators working with substantially flat vibrating screens. One such solution is disclosed in DE 10 2016 008 266 A1. In addition to the vibrating screen disposed at an angle for transporting the filter cake to an outlet due to the vibrating motion, said solution comprises interchangeable screen fixtures for disposing on the vibrating screen. While the transporting of the filter cake to the outlet functions well, the design is complex and many components are required.

Overall, the design of the known separators is complex, and effective backflushing is generally not possible. In addition, two-stage processes using a pressing screw and a downstream filter are complex and not efficient.

The object of the present invention is to disclose a separator device of the type indicated above that is improved with respect to the problems of the prior art. The separator device is to be particularly simple in design, allow effective backflushing, and be able to operate continuously.

### SUMMARY OF THE INVENTION

The object is achieved by the invention as a separator device of the type indicated above in that the at least one strainer element is movably arranged in the housing and is coupled to a drive for displacing the strainer element.

Unlike the prior art, no stationary strainer element is used in the present invention, but rather a movable element. The strainer element is moved by means of the drive, whereby liquid inside and outside the strainer element is also set in motion, so that backflushing of the strainer element is possible, depending on the direction of motion. The housing preferably forms a tank for the strainer element and said element can be disposed in said tank.

A further separator housing can also be provided for enclosing the entire device.

The various connections are provided for feeding in and discharging the corresponding liquids and/or solids. The inlet for wastewater opens into the interior of the strainer element in order to introduce the wastewater carrying fibrous material. The filtrate is then fed through a first outlet disposed in the intermediate space between the strainer element and the housing forming a container or a tank. A further outlet is provided for the fibrous material. Said material will typically not be completely dry, but rather take the form of a sludge able to be removed from the interior of the strainer element, for example by suctioning.

The strainer element preferably comprises a central axis. The strainer element is particularly preferably moved at least along a segment, preferably entirely, perpendicular to the central axis during operation. The strainer element is preferably substantially barrel-shaped or tube-shaped and preferably cylindrical or conical. Other shapes are also conceivable. The strainer element preferably comprises a strainer element wall enclosing the central axis in the radial direction. Said strainer element wall, preferably a cylindrical wall, forms the strainer area, while one or both end faces can be closed. The strainer element can also, however, be elliptical, rectangular, or polygonal in cross section, or can have any other arbitrary shape. The central axis is preferably an axis of symmetry, and the strainer element is preferably rotationally symmetrical. The central axis preferably extends substantially parallel to the strainer area.

Moving perpendicular to the central axis sets the liquid inside and outside the strainer element in motion and generates a flow through the strainer element wall, said flow also being at least partially perpendicular to the central axis. The liquid carrying fibrous material is thereby pressed against the strainer element wall in the interior of the strainer element, so that said material is pressed. Filtrate is also pressed against the strainer element wall from the outside, so that backflushing of the strainer element occurs.

The strainer element is preferably rotated about an axis of rotation at least along a segment during operation. Rotation is a particularly simple motion, and ensures that backflushing is possible at every segment of the strainer element. The strainer element is thereby preferably not rotated about the central axis thereof, but rather about the axis of rotation disposed parallel to the central axis at an eccentric distance. The axis of rotation can be a central axis of the housing, for example, or an axis of rotation of an output shaft of the drive. The eccentric distance is preferably in a range from >0 to 15 mm, preferably >0 to 10 mm, >0 to 5 mm, >0 to 3 mm, >0 to 1 mm. The value >0 is 0.1 mm, 0.2 mm, or 0.5 mm in embodiments. Said value can, however, be higher.

In a preferred embodiment, the strainer element is substantially rotationally fixed about the central axis. Rotation of the strainer element about the central axis is thus substantially avoided. Rotation about axes deviating from the central axis is preferably possible. For example, the strainer element is rotationally fixed about the central axis thereof and can be rotated or moved on a circular path about an axis of rotation. The axis of rotation is preferably parallel to the central axis or is at an angle to the same. It should be understood that a substantially rotationally fixed strainer element can perform slight rotations about the central axis. wherein a maximum angle of rotation about the central axis has a value less than or equal to 90°, preferably less than or equal to 45°, particularly preferably less than or equal to 20°, further preferably less than or equal to 10°.

The rotary motion about the axis of rotation can cause wastewater received in the strainer element to rotate, and said rotation is at least partially transferred to the strainer element. It is, therefore, preferable that the separator device comprises a fixing device mounted on the strainer element implemented for substantially fixing the strainer element relative to the central axis. The fixing device preferably allows a translatory motion of the strainer element on a path, particularly a circular path. By means of the rotational fixing, it is preferably achieved that the wastewater is uniformly separated by means of the strainer element wall.

The drive preferably comprises an eccentric, wherein the strainer element is rotatably supported on the eccentric. An axis of rotation of the eccentric is implemented offset from the central axis of the strainer element. The eccentric is preferably connected to a drive shaft of the drive. The strainer element is then preferably supported on the eccentric eccentrically to a drive axis of the drive shaft. The drive shaft is preferably driven directly by means of the motor. The drive shaft can further preferably also be driven by means of a belt drive or a chain drive. The rotatable support allows rotation of the strainer element relative to the eccentric. The strainer element can preferably be moved on a circular path by means of the eccentric and the orientation thereof about the central axis is substantially retained. The strainer element retains the orientation thereof about the central axis if a reference segment of the strainer element wall during the entire rotary motion is aligned to a corresponding reference segment of the housing. It can also be provided that the strainer element is moved on a circular path and rotated about the central axis in the same or opposite rotary direction. The orientation of the strainer element thereby changes preferably periodically. The strainer element is preferably supported on the eccentric by means of at least one rolling bearing. It can also be provided that the strainer element is supported by at least one plain bearing. The strainer element preferably comprises a strainer shaft supported on the eccentric. The strainer element can thus preferably also be supported on an eccentric lug.

The central axes are particularly preferably oriented substantially vertically in operation. It is thereby possible to achieve filtering and backflushing without a pressing screw or the like being necessary. The liquid can penetrate through the strainer element wall under the force of gravitation and additional elements can be eliminated.

In a preferred refinement, the central axis of the strainer element is angled relative to the axis of rotation. The central axis or a projection of the central axis and the axis of rotation preferably enclose an angle of inclination having a value in a range from greater than 0° to 20°, preferably greater than 0° to 15°, particularly preferably 5° to 15°.

The angle of inclination is the smaller angle formed between the axis of rotation and the central axis. The axis of rotation is preferably vertically oriented and the strainer element is inclined relative to the vertical, so that wastewater impinges non-uniformly on the wall of the strainer element due to gravitational forces. Non-uniform impinging of wastewater can thereby improve backflushing of the strainer element wall and/or prevent clogging of the strainer element wall. It can also be preferable that the central axis of the strainer element is oriented vertically and the axis of rotation is inclined relative to the vertical.

The strainer element preferably performs a tumbling motion during operation. A tumbling motion is a rotation of the strainer element about the axis of rotation spaced apart from the central axis at least along a segment, wherein no rotation is performed about the central axis. The central axis preferably intersects the axis of rotation at one axis intersection during the tumbling motion. A location of the intersection point between the axis of rotation and the central axis is particularly preferably constant during the tumbling motion. The axis intersection is preferably disposed at a first end face of the strainer element disposed proximally to the drive, or at a second end face of the strainer element opposite the first end face. Wastewater to be separated is advantageously set in rotation and/or swirled by the tumbling motion, so that a separation effect is amplified and/or clogging of the strainer element with fibrous material is prevented. The central axis of the strainer element and the axis of rotation are further preferably disposed skewed to one another. The angle of inclination is then defined between the axis of rotation and a projection of the central axis onto the axis of rotation. The central axis of the strainer element preferably extends into an eccentric plane spaced apart perpendicularly from the axis of rotation by an eccentric distance. The eccentric distance is particularly preferably constant during operation.

In a preferred embodiment, the tumbling motion of the strainer element is a superimposed motion consisting of a circular path motion and a relative lifting motion, wherein the circular path motion and the relative lifting motion are phase-shifted with respect to each other. The relative lifting motion results from a skewed inclination of the central axis relative to the axis of rotation and the rotationally fixed arrangement of the strainer element. The strainer element is rotated about the axis of rotation on a circular path during operation. Due to the rotationally fixed arrangement, the strainer element rotates relative to the drive during a circuit on the circular path, wherein the orientation is substantially constant in a global frame of reference. The strainer element wall thereby describes a relative lifting motion with respect to a housing wall enclosing the strainer element. A minimum circumferential spacing between the strainer element wall and the enclosing housing wall is thereby shifted along the axis of rotation. The lifting motion promotes filtration and/or enables backflushing of the strainer element wall. The valve body is preferably inclined such that said body lags behind the rotation. A first end face of the strainer element disposed proximally to the drive thereby preferably lags behind a second end face of the strainer element opposite the first end face during a circuit on the circular path. The central axis of the strainer element preferably describes a cylindrical surface during operation. It can, however, also be preferable that the first end face of the strainer element precedes the second end face.

A phase shift between the circular path motion and the relative lifting motion preferably has a value in a range from 5° to 180°, preferably 45° to 135°, particularly preferably 90°. The phase shift is preferably selected such that a segment of the strainer element wall disposed proximally to the housing wall simultaneously sees the greatest acceleration and a maximum relative velocity of the lifting motion.

In a preferred refinement, the strainer element is coupled to the drive by means of a joint element. The joint element is particularly preferably disposed between the strainer element and the eccentric. The joint element is preferably torsionally rigid in design and enables tilting the central axis of the strainer element, so that said strainer element is substantially rotationally fixed about the central axis during the tumbling motion. Preferably, the joint element is at least partially made of an elastomer material.

In a preferred embodiment, the drive comprises a motor and a drive shaft extending into the housing and coupled to the at least one strainer element for rotationally driving the strainer element. Said drive shaft can be guided directly or indirectly into the housing. A gearbox is preferably disposed between the motor and the drive shaft. The motor can be implemented particularly as an electric motor.

In a further preferred embodiment, a press device is provided within the strainer element and is implemented for changing a distance from a strainer element wall during operation for pressing fibrous material against the strainer element wall. The press device is intended for compacting and dehydrating the fibrous material at the strainer element wall and for contributing in this manner to a type of “wringing” function and/or “squeezing” function. A greater degree of dehydrating the fibrous material can thereby be achieved.

In a preferred embodiment, the press device comprises a bar-shaped or ring-shaped press element. The longitudinal axis of the bar-shaped or ring-shaped press element is preferably aligned substantially parallel to the central axis of the strainer element, so that the bar-shaped or ring-shaped press element can extend substantially over the entire axial extent of the strainer element wall. It is thereby possible to achieve a pressing or wringing function along the entire axial length of the strainer element wall, and to achieve effective dehydrating of the fibrous material. It is thereby not necessary, but is preferable, that the bar-shaped or ring-shaped press element is cylindrical. There can also be embodiments wherein an oval cross section of the press element is advantageous.

It can thereby be provided that the press element is freely movable within the strainer element. The strainer element is moved, and thereby the press element is as well. If the press element is freely movable within the strainer element, said body is subjected to inertial forces and moves in the direction of the strainer element during the rotary motion of the strainer element.

Alternatively, the press element can be guided or stationary within the strainer element. The strainer element is moved and thereby the distance between the strainer element wall and the press element changes, so that a pressing or wringing function is achieved.

The press element is preferably fixed on a first side of the housing opposite the drive. For example, the press element can be screwed to the housing. Further adhesive, form-fit, and/or force-fit attachments are also preferable. In a particularly preferred embodiment, the housing comprises a cover, wherein the press element is fixed on the cover and can be used with the same at the separator device. It can be provided that the press element extends along the axis of rotation.

In a preferred refinement, the press element extends into the strainer element in a range from about 20% to 100%, preferably 50% to 100%, particularly preferably 70% to less than 100% of a length of the strainer element, measured between a first end face of the strainer element disposed proximally to the drive, and a second end face of the strainer element opposite the first end face. By extending the press element into the strainer element, a volume of the strainer element and/or a separating effect can be adjusted. A diameter of the press element is preferably selected such that contact between the press element and the strainer element is avoided when the strainer element is moved. The press element particularly preferably extends from the second end face to approximately just above a floor of the strainer element.

In a preferred embodiment, the second outlet is connected to the strainer element by means of a flexible discharge. The flexible discharge preferably allows rotating of the strainer element about the axis of rotation and is particularly preferably torsionally rigid in design. It can be provided that the flexible discharge fixes the strainer element rotationally about the central axis. To this end, the flexible discharge can be preferably rotationally fixedly connected to the housing. It should be understood that the flexible discharge can also comprise non-flexible elements.

The flexible discharge is preferably connected to the strainer element in a fully circumferentially sealing manner. Fibrous material then exits the strainer element into the flexible discharge and can reach the second outlet. The flexible discharge particularly preferably connects entirely to an end face of the strainer element. For example, the flexible discharge can be fitted over the strainer element and thus connected to the same. The flexible discharge is preferably releasably connected to the strainer element. A tube collar or a clamping ring can be provided for this purpose. It should be understood, however, that the flexible discharge can also be non-releasably connected to the strainer element.

The flexible discharge is preferably connected to a second end face of the strainer element opposite the first end face of the strainer element disposed proximally to the drive. The fibrous material is thus discharged via the second end face of the strainer element. Both the flexible discharge and the press element are particularly preferably disposed on the second end face of the strainer element.

In a preferred embodiment, the flexible discharge comprises a discharge hose connected at a first end to the strainer element. The first end of the discharge hose is preferably placed over the strainer element and fixed to the strainer element by means of a hose clamp. The flexible discharge preferably comprises at least two discharge hoses preferably uniformly distributed over the circumference of the strainer element. The flexible discharge can further preferably comprise a bellows, a spiral hose, and/or pipe segments joined in an articulated manner. The flexible discharge can further comprise one or more coupling elements, one or more cylindrical pipes, and/or one or more pipe elbows. The discharge hose particularly preferably opens into a discharge pipe connected to the second outlet.

A second end of the discharge hose is preferably connected to the housing for substantially rotationally fixing the strainer element. Fixing the second end of the discharge hose to the housing causes the discharge hose to be rotationally fixed, so that said hose cannot rotate about the longitudinal axis thereof extending between the first end and the second end. The discharge hose is preferably torsionally rigid in design, so that rotation of the strainer element connected to the first end of the discharge hose is prevented. It should be understood that the discharge hose can allow slight torsion about the longitudinal axis thereof, whereby the strainer element can perform slight rotary motions about the central axis thereof. A maximum rotation angle of the strainer element about the central axis thereof can be preferably adjusted by means of the torsional rigidity of the hose. Slight rotations of the strainer element about the central axis thereof can be advantageous, for example, for preventing solid material present in the wastewater from clogging. The discharge hose is also preferably bendable about the longitudinal axis thereof, so that said hose allows rotation of the strainer element about the axis of rotation. If the strainer element is moved along a circular path, then the first end can preferably follow the motion, wherein the second end is stationary. It can, however, also be preferable that the flexible discharge fixes the strainer element about the axis of rotation and the central axis and allows tilting of the central axis of the strainer element.

The housing preferably comprises a support element, wherein the discharge hose is attached to the support element. The support element can extend partially into a hollow space formed by the housing. The support element is particularly preferably implemented as a plate in the housing and comprises a pass-through channel for the fibrous material. A pipe segment of the flexible discharge can also preferably implement the support element or be connected to the support element. In a preferred refinement, the discharge hose can be connected to the housing by means of a rotary joint, so that said hose allows rotating of the strainer element about the central axis.

The press element is preferably disposed at least partially within the flexible discharge and forms a discharge channel with the flexible discharge. The press element preferably extends completely through the discharge hose. It can also be provided, however, that the press element runs substantially parallel to the flexible discharge. The discharge channel is preferably implemented as an annular channel. A cross-sectional flow area of the discharge channel is preferably less than a cross-sectional area of the strainer element. The discharge channel preferably allows circumferentially symmetrical discharge of the fibrous material out of the strainer element.

In a preferred embodiment, the inlet is connected to the interior of the strainer element by means of a flexible infeed. The flexible infeed allows rotation of the strainer element about the axis of rotation. The flexible infeed preferably also allows rotating about the central axis. The flexible infeed can also preferably fix the strainer element rotationally about the central axis thereof. The flexible infeed is particularly preferably implemented as substantially torsionally rigid.

In a preferred refinement, the flexible infeed is connected to the strainer element in a fully circumferentially sealing manner. For example, the flexible infeed can be fitted over the strainer element and thus connected to the same. It can also be provided, however, that the flexible infeed opens into the strainer element in a sealing manner.

The flexible infeed is preferably connected to a first end face of the strainer element disposed proximally to the drive. The flexible infeed is particularly preferably opposite the flexible discharge. By means of such an embodiment, uniform flow of the wastewater through the strainer element can be achieved. The first end face is particularly preferably disposed in a vertical direction below the second end face of the strainer element, so that the wastewater is fed into the strainer element from below. Discharging of the fibrous material is also preferably done from above. A gravity-powered discharge of the fibrous material from the strainer element is thereby prevented.

According to a preferred embodiment, the flexible infeed comprises at least one infeed hose. The flexible infeed can also comprise an infeed bellows, a spiral hose, or pipe segments joined in an articulated manner. The infeed hose is preferably bendable about the longitudinal axis thereof. The flexible infeed preferably comprises a first infeed hose and a second infeed hose, wherein the second infeed hose extends at least partially within the first infeed hose for forming an infeed channel. The infeed channel is preferably implemented as an annular channel. It can be provided that a drive shaft of the drive extends through the second infeed hose. It can thereby be advantageously prevented that one or more elements of the drive come into contact with wastewater. The first infeed hose and the second infeed hose can also be disposed adjacent to each other. The flexible infeed particularly preferably comprises a plurality of infeed hoses distributed uniformly at an end face of the strainer element. The flexible infeed preferably further comprises a manifold implemented for feeding in the wastewater to the infeed channel. The manifold is preferably implemented as a pipe elbow connected to the inlet.

It can be provided that the first infeed hose is fully sealingly connected to a cylindrical surface of the strainer element, and that the second infeed hose is sealingly connected to a step of the strainer element. The first infeed hose is preferably placed over the strainer element and fixed thereon. The second infeed hose sealingly connects to a step of the strainer element, wherein the strainer element preferably comprises one or more infeed openings disposed between the step and the cylindrical surface of the strainer element. In order to enable infeeding the wastewater in as circumferentially symmetrical a manner as possible, the infeed openings can also be implemented as segments of an annular gap.

In a preferred embodiment, the separator device comprises a feed pump for feeding the wastewater into the first strainer element under pressure. The housing is preferably closed, so that a pressure in the interior of the housing is greater than an ambient pressure. A pressure gradient preferably exists between the interior of the strainer element and the first outlet for the filtrate, so that the filtrate is pressed through the strainer element.

The first outlet preferably comprises a shut-off valve implemented for adjusting a first discharge pressure for the filtrate. The shut-off valve is preferably implemented as a ball valve, as a pinch valve, or as a gate valve. It can also be provided that the second outlet comprises a shut-off valve implemented for adjusting a second outlet pressure for the fibrous material. It should be understood that the shut-off valve can also be disposed upstream of the first outlet and fluidically connected to the first outlet. The shut-off valve can also be disposed downstream of the second outlet and fluidically connected to the second outlet

The first discharge pressure is preferably lower than the second discharge pressure. In this case, a pressure gradient between the interior of the strainer element and the first outlet is greater than a corresponding pressure gradient between the interior of the strainer element and the second outlet. A separation effect of the separator device can thereby be improved. Filtrate is thereby pressed through the strainer element wall by the pressure gradient. A ratio of the first discharge pressure to the second discharge pressure further influences a residual content of filtrate remaining in the fibrous material.

In a preferred embodiment, the separator device comprises an inlet pipe forming the inlet and extending into the interior of the strainer element substantially along the axis of rotation. The inlet pipe extends preferably substantially completely through the strainer element. If the strainer element, as described above, is preferably substantially vertically oriented, then in this case the inlet pipe extends preferably from the top to approximately just above the baseplate of the strainer element. In this case, the inlet pipe can form the press element. The diameter of the inlet pipe can be selected so that a sufficient wringing function is achieved. It should be understood that wringing out can also constitute pressing, preferably by applying force perpendicular to the strainer element. It is also conceivable that the inlet pipe be enclosed in a second sleeve, so that a sufficient diameter is achieved. Variation of the wall thickness of the inlet pipe can also be considered.

The invention further relates to a separator device for separating fibrous material from wastewater, having a housing comprising at least one inlet for wastewater, at least one first outlet for filtrate, and at least one second outlet for the fibrous material, and having at least one hollow strainer element disposed in the housing, the inlet opening being disposed in an intermediate space between the housing and the strainer element, and the first outlet being disposed in the interior of the strainer element, characterized in that the at least one strainer element is movably disposed in the housing and coupled to a drive for displacing the strainer element. A press element is preferably disposed in the intermediate space. With respect to advantageous embodiments of said separator device, reference is made to the entirety of the above description of the first consideration of the invention.

In a further embodiment of the invention, the drive comprises an oscillation gearbox for driving the strainer element in an oscillating manner. Both types of motion should be considered in general, that is, continuously rotating about the axis of rotation and oscillating. It is also conceivable that said two operating modes are performed alternately or according to a particular schema. When oscillating, a back-and-forth vibration of the liquid can be achieved within the strainer element, whereby fibrous material automatically accumulates on the inner surface of the strainer element. Particularly, simple backflushing is also thereby achieved. Thus, filtration always takes place under oscillation at the trailing side of the strainer element, while backflushing is performed at the leading side of the strainer element. Buildup of fibrous material at the strainer element and thus blocking of the strainer element can thus be prevented.

According to a preferred embodiment, at least two strainer elements are provided, particularly at least three, at least four, at least five. A preferred quantity has been determined to be a quantity of less than ten strainer elements. For example, four strainer elements present a good quantity for enabling efficient filtering of the liquid while nevertheless not leading to increased design effort. In such an embodiment, it is preferably provided that the at least two strainer elements are disposed so that the axis of rotation is outside of the strainer element. Preferably, however, all strainer elements have a common axis of rotation. That is, in the present embodiment the strainer elements rotate jointly about the common axis of rotation. An oscillating drive is particularly preferred for such embodiments. It is thereby also particularly suitable if a freely movable press element is disposed within each strainer element.

The strainer elements can thereby also be connected by means of flexible hoses for feeding in and removing liquid or sludge in such cases. This is particularly simple if the strainer elements are moved in an oscillating manner and do not continuous rotate in one direction.

The strainer element preferably has a mesh size of 10 μm to 300 μm. The mesh size is preferably in a range from 100-300 μm, preferably 150-250 μm. It is further preferable that the mesh size is in a range from 10 μm to 100 μm, preferably 10 μm to 50 μm. The exact mesh size can depend on the type of wastewater to be filtered, particularly from the objective of separating and the type of fibrous material. A mesh size in a range from approximately 300-100 μm is preferred for coarse separation and a mesh size in a range from 10-100 μm for fine separation of watery wastewater.

A plurality of strainer elements can also be placed concentrically one inside the other. The mesh size then preferably decreases from the inside to the outside. For example, an inner strainer element can have a mesh size in a range from approximately 300-100 m, and strainer element further outside can have a mesh size of approximately 10-100 μm.

In a second consideration of the invention, the object stated above is achieved by a method for separating fibrous material from wastewater, particularly using a separator device according to any one of the preferred embodiments of a separator device according to the first consideration of the invention, as described above.

The method preferably comprises at least the following steps: feeding wastewater carrying fibers into a strainer element; moving the strainer element; filtering wastewater at the strainer element; discharging filtrate out of an intermediate space between the strainer element and a housing; discharging fibrous material from the interior of the strainer element. The steps of the method for separating fibrous material are preferably performed at least partially simultaneously and/or continuously. The moving preferably comprises oscillation. It can also be provided that the displacing comprises a tumbling motion. The tumbling motion preferably induces a flow parallel to an axis of rotation and/or a flow about the central axis of the strainer element.

It should be understood that the separator device according to the first consideration of the invention and the method according to the second consideration of the invention have identical and similar sub-considerations, as are particularly set forth in the dependent claims. In this respect, reference is made to the entire above description of the separator device according to the first consideration of the invention.

A preferred embodiment of the method comprises the steps: filtering wastewater at a first segment of the strainer element trailing with respect to a direction of motion; and backflushing of the strainer element in a second segment of the strainer element leading with respect to the direction of motion. Said steps are preferably performed when the moving comprises oscillating. Permanent accumulation of fibrous material at the strainer element wall can be prevented, and dehydrated sludge having a high concentration of fibrous material can be discharged via the second outlet.

It is further preferable that the method comprises: pressing fibrous material by means of a press element against an inner side of the strainer element wall of the strainer element. In a preferred refinement of the method, the strainer element is rotationally fixed about the central axis.

Embodiments of the invention are described below using the drawings. Said drawings are not necessarily intended to depict the embodiments to scale; rather, the drawings are shown in schematic and/or slightly distorted form for explanatory purposes. With respect to supplements to the teachings directly discernible from the drawings, reference is made to the applicable prior art. It must thereby be considered that various modifications and changes relating to the shape and detail of an embodiment can be made without deviating from the general idea of the invention. The features of the invention disclosed in the description, in the drawings, and in the claims can be essential to the refinement of the invention individually and in any arbitrary combination. All combinations of two or more features disclosed in the description, the drawings, and/or the claims also fall within the scope of the invention. The general idea of the invention is not limited to the precise form or the detail of the preferred embodiments shown and described below or limited to a subject-matter that would be limited in comparison with the subject-matter claimed in the claims. Where dimensional ranges are indicated, values within the stated limits should also be disclosed as limit values and arbitrarily usable and claimable. For simplicity, identical reference numerals are used below for identical or similar parts or parts having identical or similar functions.

### BRIEF DESCRIPTION OF THE DRAWINGS

Further advantages, features, and details of the invention result from the below description of the preferred embodiments and from the drawings, which show:

FIG. 1 is schematic cross section of a first embodiment of a separator device;

FIG. 2 is a cross section along the line A-A according to FIG. 1;

FIG. 3 is a schematic cross section of a second embodiment of a separator device;

FIG. 4 is a cross section along the line B-B according to FIG. 3;

FIG. 5 is a cross section through a strainer element according to the second embodiment example;

FIG. 6 is a cross section of a third embodiment of a separator device;

FIG. 7 is a cross section of the third embodiment of the separator device, perpendicular to the cross section shown in FIG. 6;

FIG. 8 is a schematic cross section of a fourth embodiment of a separator device;

FIG. 9A is a schematic plan view of the separator device according to a fifth embodiment;

FIG. 9B is a plan view of the separator device according to FIG. 9A, wherein the eccentric has been rotated by 90°,

FIG. 10A is a schematic side view of a sixth embodiment of a separator device;

FIG. 10B is a schematic side view of the separator device according to FIG. 10A, wherein the strainer element has been rotated clockwise 270°;

FIG. 11A is a schematic side view of the separator device according to the fifth embodiment, analogous to the position in FIG. 9B, and

FIG. 11B is a schematic side view of the separator device according to FIG. 10B, wherein the strainer element has been rotated counterclockwise 90°.

### DETAILED DESCRIPTION OF THE EMBODIMENTS

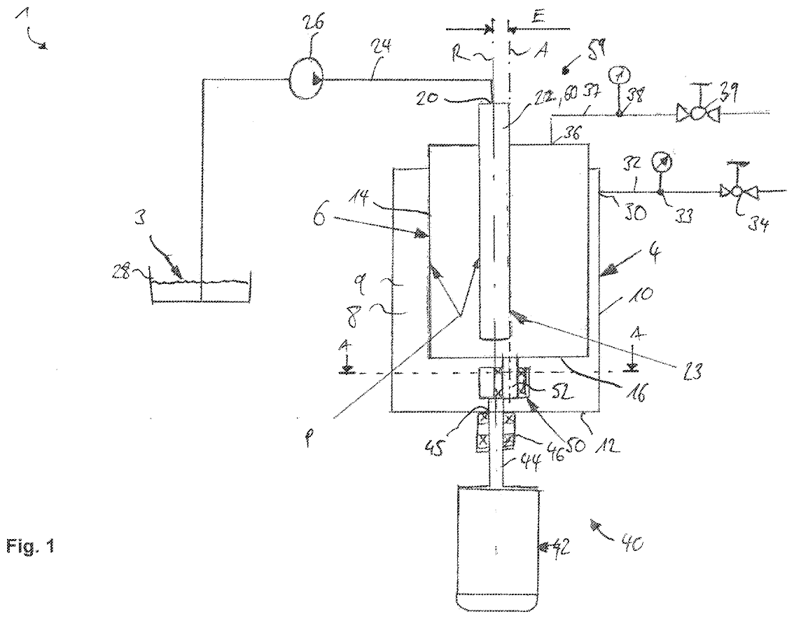

According to FIG. 1, a separator device 1 for separating fibrous material 2 (cf. FIG. 5) from wastewater 3 comprises a housing 4 and a strainer element 6 disposed therein. The housing 4 in the present embodiment is substantially barrel-shaped in design and provides a container defining an interior space 8. The housing 4 has a side wall 10, for example, potentially cylindrical, and a floor 12. The strainer element 6 is placed in the interior space 8. The strainer element 6 is also substantially barrel-shaped, and in the present embodiment example is cylindrical. The strainer element 6 comprises a strainer element wall 14 forming a strainer area. The strainer area preferably has a mesh size of 10-300 μm. The lower end face of the strainer element 6 with respect to FIG. 1 comprises a base plate 16 closing off the strainer element 6 at the bottom end.

The housing 4 has an inlet 20 for wastewater 3. The inlet 20 is formed in the present embodiment example (FIG. 1) by an inlet pipe 22 extending into the interior of the strainer element 6 and ending near the base plate 16. The inlet 20 is further connected to a hose or a line 24 in which a pump 26 is placed in order to pump wastewater 3 from a wastewater tank 28 to the inlet 20.

Once wastewater 3 has been fed through the inlet pipe 22 into the interior of the strainer element 6 by means of the pump 26, said wastewater is filtered by means of the strainer element wall 14, so that filtrate enters an intermediate space 9 between the housing wall 10 and the radially outer side of the strainer element 6. In order to remove the filtrate from the intermediate space 9, the housing 4 comprises a first outlet 30 for filtrate. The first outlet 30, in turn, is connected to a line 32 in which a pressure gage 33 and a shut-off valve 34 are placed. During operation, filtrate is typically removed at approximately 0.7 bar.

In order to remove the fibrous material 2 or the filter cake from the interior of the strainer element 6, the housing 4 comprises a second outlet 36, shown only schematically in FIG. 1. Said second outlet 36, in turn, is connected to a line 37 in which a pressure gage 38 and a shut-off valve 39 are placed. The sludge is typically removed at a pressure of approximately 1 bar.

The separator device 1 further has a drive 40 comprising an electric motor 42 in the present embodiment example. The electric motor 42 in the present embodiment example (FIG. 1) is not provided with a gearbox, but rather is directly connected to a drive shaft 44. The drive shaft 44 extends along an axis of rotation R through an opening 45 in the base plate 12 and is supported in a bearing 46. The drive shaft 44 is connected to an eccentric 50 in the interior of the housing 4. The eccentric 50 rotatably supports a strainer shaft 52 in turn rigidly connected to the base plate 16 of the strainer element 6. The strainer element 6 has a central axis A and can rotate relative to the same due to the rotatable supporting thereof on the eccentric 50. The eccentric 50 rotates about the axis of rotation when the drive shaft 44 turns, so that the strainer element 6 is also rotated altogether about the axis of rotation R.

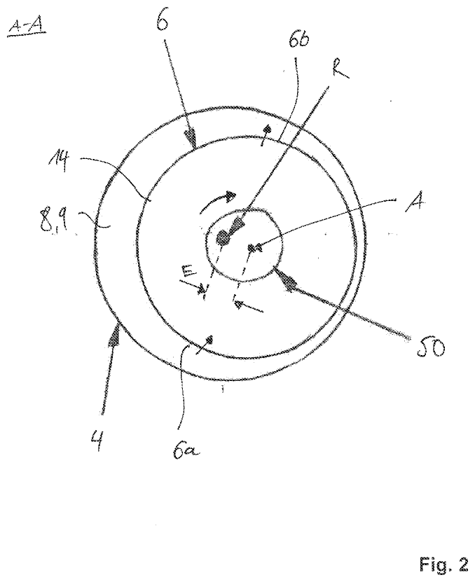

The central axis A of the strainer element 6 is disposed offset to the axis of rotation R by an eccentric distance E. In this manner, it is achieved that the strainer element 6 is always moved perpendicular to the central axis A thereof when the drive shaft 44 is rotated, whereby movement of the liquid within the strainer element 6 and outside thereof in the intermediate space 9 is achieved. Said configuration can be seen particularly well in FIG. 2. FIG. 2 shows a cross section along the line A-A according to FIG. 1. The eccentric 50 rotates clockwise (cf. curved arrow) about the axis of rotation R. The eccentric 50 supports the strainer element 6 along the central axis A thereof. That is, the central axis A rotates about the axis of rotation R, together with the strainer element 6, at the eccentric distance E. In this manner, the strainer element 6 is moved in a rotary motion through the interior space 8 of the housing 4, so that the geometry of the intermediate space 9 changes. On a leading side 6a of the strainer element 6, the strainer element 6 thus presses liquid away in the intermediate space 9, wherein part of said liquid is forced through the strainer element wall 14 from the outside to the inside (cf. arrow). In said leading region 6a, therefore, fibrous material 2 adhering to the inner surface of the strainer element wall 14 is backflushed and thus released. Clogging of the strainer element wall 14 can be prevented.

In a similar manner, liquid in a trailing segment 6b of the strainer element wall 14 is pressed through the strainer element wall 14 from the inside to the outside and is thus filtered. In addition, due to the flow, compacting of the fibrous material 2 against the inner wall of the strainer element 6 can occur here, whereby the filtration is more efficient.

With reference to FIG. 1 it can further be seen that the inlet pipe 22 is stationary and extends along the axis of rotation R. That is, when the strainer element 6 rotates, said axis also rotates relative to the inlet pipe 22, whereby a distance P (cf. FIG. 1) between the inner surface of the strainer element wall 14 and the outer surface 23 of the inlet pipe 22 varies. The inlet pipe 22 thus leads further to movement of the liquid within the strainer element 6. The inlet pipe 22 can thereby press fibrous material 2 against the inner surface of the strainer element wall 14 when the relative distance P between the inlet pipe 22 and the strainer element wall 14 is small, that is, on the left side with reference to FIG. 1. In this case, the inlet pipe 22 acts as a press element 60. Pressing of the fibrous material 2 against the inner surface of the strainer element wall 14 is thereby achieved, and thus a “wringing” and/or “pressing” effect is achieved. The inlet pipe 22 is substantially cylindrical here, but can also have any other shape or any other cross section, and can particularly be conical in shape.

By dimensioning the outer diameter of the inlet pipe 22 accordingly, said effect can be influenced in a targeted manner.

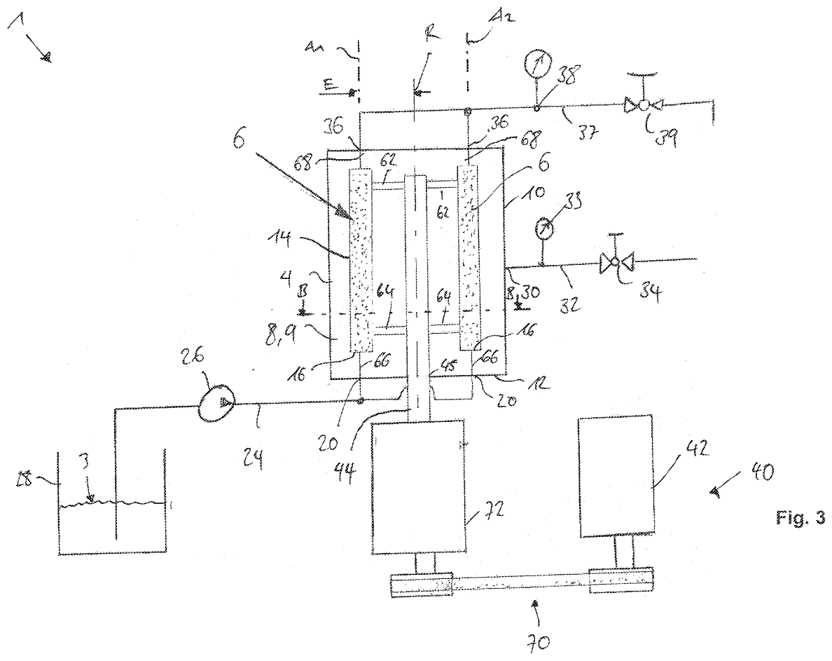

An embodiment example modified with respect to the above is shown in FIGS. 3 through 5. Identical and similar elements are labeled with identical reference signs, so that full reference is made to the above description of the first embodiment example.

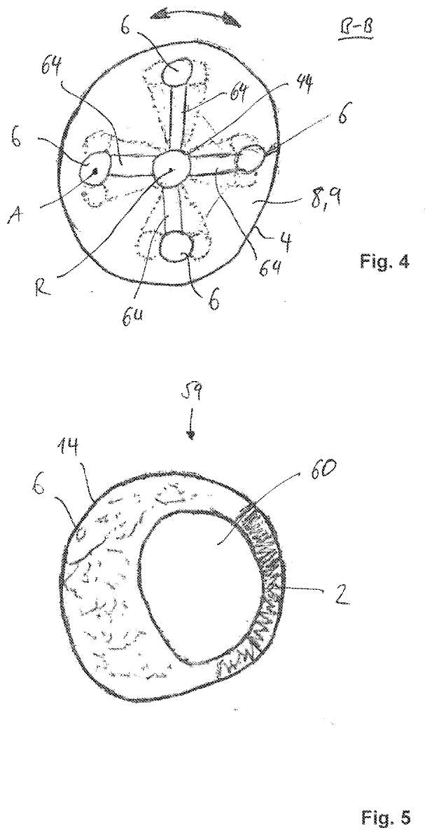

A first difference in the separator device 1 according to the second embodiment example (FIGS. 3-5) is that a total of four strainer elements 6 are placed in the housing 4 (cf. FIG. 4). Said four strainer elements 6 are substantially smaller in diameter than the one strainer element 6 according to the first embodiment example. The strainer elements 6 are each connected by means of two support struts 62, 64 to a drive shaft 44 extending through the opening 45 in the base plate 12 of the housing 4. The drive shaft 44 in turn comprises an axis of rotation R, and each of the strainer elements 6 comprises a central axis A (A1, A2, A3, A4). The drive shaft 44 is rotatable about the axis of rotation R, so that the strainer elements 6 can be rotated about the axis of rotation R at an eccentric distance E. The axis of rotation R thus presents a common axis of rotation for all of the strainer elements 6 disposed in the housing 4.

Due to the plurality of strainer elements 6 in the present embodiment example (FIGS. 3-5), a plurality of inlets 20 are also provided, implemented in the base plate 12. The inlets 20 are each connected in the present embodiment example to flexible hoses 66 extending through corresponding openings in the base plates 16 of the strainer elements 6. Flexible hoses 66 are therefore advantageous, as a certain rotation of the strainer element 6 relative to the base plate 12 of the housing 4 must be allowed. Other embodiments could also comprise a manifold housing, wherein the introducing of wastewater is possible or not, depending on the rotational orientation.

In a similar manner, the separator device 1 also comprises a plurality of second outlets 36, namely, exactly four, wherein each of the plurality of second outlets 36 is associated with a strainer element 6. The second outlets 36 in turn are connected to flexible hoses 68 extending into the interior of the particular strainer element 6, so that fibrous material 2 can be removed from the interior of each strainer element 6.

A further difference is present in the drive 40. Said drive in turn comprises an electric motor 42, in the present embodiment example (FIGS. 3-5), however, initially connected to an oscillation gearbox 72 by means of a belt drive 70. The oscillation gearbox 72 then comprises the drive shaft 44 extending into the housing 4. The oscillation gearbox 72 serves for changing a continuously rotating drive motion of the electric motor 42 to an oscillation of the drive shaft 44 about the axis of rotation R. This is particularly advantageous in the present embodiment example, as a plurality of strainer elements 6 are provided and connected to the associated inlets 20 or second outlet 36 by means of flexible hoses 66, 68. The oscillation in the present embodiment example is, in turn, a rotation performed only in a certain angle range, for example 10°. Other angle ranges can also be preferable, particularly a range from 5-180°, preferably 5-90°, further preferably 5-15° A range of angles less than 5°, for example 1-5°, is also preferable. It has been surprisingly determined that small strokes enable effective and efficient separation. An increased frequency can also be applied at the same time as small strokes. The frequency is preferably in a range from 15 Hz to 50 Hz.

The oscillating motion is shown in FIG. 4. There, a section along the line B-B according to FIG. 3 can be seen, so that the four strainer elements 6 are evident in section. The strainer elements 6 are each offset from each other by about 90°, resulting in a star-shaped arrangement about the drive shaft 44. Eight strainer elements 6 can also be provided, or the strainer elements 6 each have an overall greater diameter. The dashed lines indicate that the drive shaft 44 oscillates, that is, is moved back and forth clockwise and counterclockwise with respect to FIG. 4.

FIG. 5 shows an enlarged section view of the strainer element 6 according to the second embodiment example. The separator device 1 according to the second embodiment example, just like the separator device 1 according to the first embodiment example, comprises a press device 59 comprising a press element 60. The press element 60 is substantially bar-shaped and placed in the interior of the strainer element 6. Said element is freely movable in the interior of the strainer element 6. If the strainer element 6 is moved back and forth as shown with respect to FIG. 4, the press element 60 also moves back and forth and is subjected to inertial forces. If the strainer element 6 is moved to the left, for example, or has been moved to the right and then decelerated, that is, is subjected to an acceleration to the left with respect to FIG. 5, then the press element 60 is moved to the right with respect to FIG. 5 and presses the fibrous material 2 together on the right side with respect to FIG. 5, that is, presses said fibrous material 2. A “wringing” effect is thereby achieved and the fibrous material 2 can be further dehydrated.

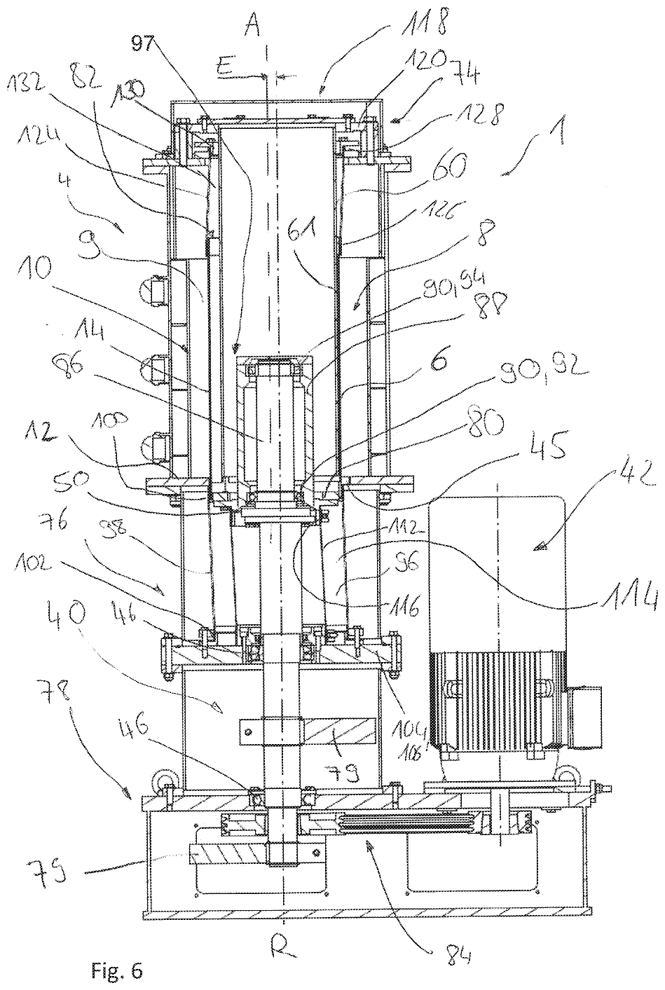

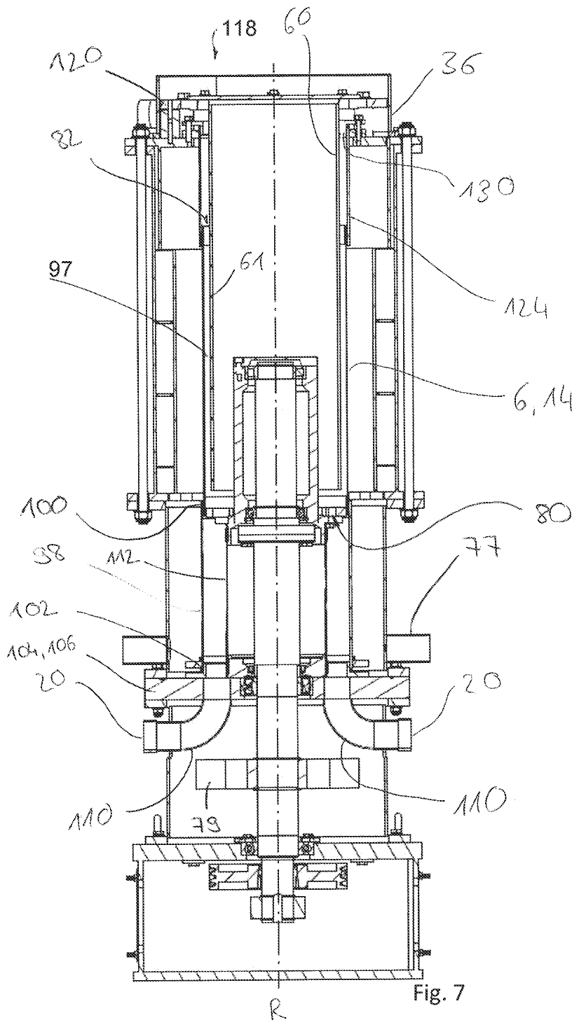

According to a third embodiment (FIGS. 6, 7), the separator device 1 comprises a housing 4 and a strainer element 6 disposed therein. Identical and similar elements are in turn labeled with the same reference signs as were used in the first two embodiment examples. In this respect, full reference is made to the description above.

The housing 4 in the third embodiment is substantially cylindrical in design and defines an interior space 8. A side wall 10 of the housing 4 is cylindrical in design and the housing 4 further comprises a floor 12 and a cover 74. With respect to FIG. 6, the housing 4 comprises a drive segment 76 below the floor 12 and connected to a base frame 78 of the separator device 1. The strainer element 6 is placed in the interior space 8, wherein the strainer element 6 in the present embodiment extends through the floor 12. For maintenance purposes, the drive segment 76 comprises a maintenance outlet 77 (not shown in FIG. 6). The strainer element 6 in the third embodiment example is also cylindrical and has a base plate 16 on a first end face 80 disposed proximally to the drive 40. The strainer element 6 is open at a second end face 82 opposite the first end face 80.

The drive 40 has an electric motor 42 connected to a drive shaft 44 by means of a belt drive 84. The drive shaft 44 is rotatably supported in the base frame 78 and in the drive segment 76 of the housing 4 by means of the bearings 46. The drive shaft 44 extends along an axis of rotation R through an opening 45 in the floor 12 and is connected to the eccentric 50. An imbalance of the drive shaft 44 caused by the eccentricity E of the eccentric 50 and the strainer element 6 is preferably compensated for by means of the balancing weights 79. The strainer element 6 comprises a bearing shell 88 here, rotatably supported on an eccentric lug 86 of the eccentric 50 by means of the rotatable bearings 90, implemented here in a fixed and floating arrangement. The fixed bearing 92 is implemented as a ball bearing and the floating bearing 94 as a cylindrical rolling bearing. It should be understood that the strainer element 6 can also be supported on the eccentric 50 by means of other forms of rolling bearings or by means of a plain bearing. The bearings 90 can also be implemented as a queued bearing arrangement. The eccentric 50 is connected to the drive shaft 44 such that the central axis A has an eccentric distance E from the axis of rotation R. If the drive shaft 44 is caused to rotate about the axis of rotation R by means of the electric motor 42 and the belt drive 84, then the strainer element 6 rotates on a circular path about the axis of rotation R. A radius of the circular path is determined by the eccentric distance E.

The housing 4 has an inlet 20 for wastewater 3 (not shown in FIG. 6, cf. FIG. 7) connected to the interior 97 of the strainer element 6 by means of a flexible infeed 96. In the present embodiment example, the flexible infeed 96 comprises a first infeed hose 98 fully sealingly connected to the strainer element 6 at the first end face 80. A first end 100 of the first infeed hose 98 is placed over the strainer element wall 14 and fixed thereon. The first infeed hose 98 is preferably releasably fixed on the strainer element 6, particularly preferably by means of a hose clamp (not shown in FIG. 6). A second end 102 of the first infeed hose 98 is sealingly clamped on a first intermediate plate 104 of the housing 4. A through hole 108 (FIG. 7) is implemented in the first intermediate plate 104, serving here as a support element 106 for the flexible infeed 96. A pipe elbow 110 serves for feeding in the wastewater 3 from the inlet 20 to the infeed hose 98. The flexible infeed 96 can also comprise a plurality of first infeed hoses 98 opening into the strainer element. In the third embodiment example, a second infeed hose 112 is disposed within the first infeed hose 98 and forms an infeed channel 114 with the first infeed hose 98. The second infeed hose 112 is sealingly connected to a step 116 of the strainer element 6 and to the intermediate plate 104 at opposite ends. The first infeed hose 98 and the second infeed hose 112 are flexible, so that the flexible element 96 allows rotation of the strainer element 6 about the axis of rotation R. The first infeed hose 98 and the second infeed hose 112 are also substantially torsionally rigid in design, so that said hoses 98, 112 substantially prevent rotation of the strainer element 6 about the central axis A. The drive shaft 44 runs within the second infeed hose 112, so that a contact between the bearings 46 and the wastewater 3 is prevented. The flexible infeed 96 can preferably comprise a bellows and/or a pipe supported on the strainer element 6 and on the first intermediate plate 104 in an articulated manner.

The inlet 20 can be connected to a hose or a line 24 in which a pump 26 is placed in order to pump wastewater 3 from a wastewater tank 28 to the inlet 20. Once wastewater 3 has been fed into the interior space 97 of strainer element 6 through the inlet 20, the pipe elbow 110, and the infeed channel 114, said wastewater 3 is filtered by means of the strainer element wall 14, so that filtrate enters an intermediate space 9 between the housing wall 10 and the radially outer side of the strainer element 6. In order to remove the filtrate from the intermediate space 9, the housing 4 comprises a first outlet 30 for filtrate (not shown in FIGS. 6 and 7). The first outlet 30 is in turn connected to a line 32 and can comprise a pressure gage 33 and a shut-off valve 34 (not shown in FIGS. 6 and 7). The shut-off valve 34 serves for adjusting a first outlet pressure.

In the third embodiment example, the separator device 1 comprises a press element 60 fixed on a second support element 120 of the housing 4 on a first side 118 of the housing opposite the drive. The press element 60 is implemented here as a hollow cylindrical element extending along the axis of rotation R for approximately 90% of a length of the strainer element 6, measured between the first end face 80 and the second end face 82, in the interior space 97 of the strainer element 6. If the strainer element 6 rotates about the axis of rotation R, a distance between a press element wall 61 of the press element 60 and the strainer element wall 14 varies, so that a “wringing effect” and/or a “pressing effect” reinforces the separating effect. Contact between the components is preferably avoided in order to minimize wear of the press element 60 and the strainer element 6. In order to scrape off solids adhering to the strainer element wall 14, however, it can be preferable that the strainer element 6 rubs against the press element 60. The press element wall 61 preferably comprises wiping elements to this end.

A flexible discharge 122 connects the second outlet 36 to the strainer element 6. To this end, the flexible discharge 122 comprises a discharge hose 124 sealingly connected at a first end 126 to the strainer element 6. The first end 126 of the discharge hose 124 is placed over the second end face 82 of the strainer element 6 and fixed thereon. A second end 128 of the discharge hose 124 is sealingly connected to the second support element 120, wherein the second support element 120 comprises a pass-through channel 130. The pass-through channel 130 guides the fibrous material 2 to the second outlet 36 (not shown in FIG. 6, cf. FIG. 7). The flexible discharge 122 can comprise a pressure gage 38 and a shut-off valve 39, wherein the shut-off valve 39 is implemented for adjusting a second outlet pressure. The pressure gage 38 and the shut-off valve 39 can also be placed in a line 37 connected downstream to the second outlet 36. The discharge hose 124 can also be implemented as a bellows or an articulated pipe. The strainer element 6 is connected to the second support element 120 by the discharge hose 124 and is supported in a rotationally fixed manner, wherein the discharge hose 124 is preferably torsionally rigid. The discharge hose 124 is also bendable about the longitudinal axis thereof and thus allows the rotary motion of the strainer element 6 about the axis of rotation R. It can also preferably be that the second end face 82 of the strainer element 6 is closed by a cover allowing relative motion of the strainer element 6 to the press element 60. The flexible discharge 122 can then comprise one or more discharge hoses 124 opening into the cover and preferably uniformly distributed over the circumference of the cover. The press element 60 extends within the discharge hose 124, wherein the press element wall 61 and the discharge hose 124 define a discharge channel 132.

A cross-sectional area of the discharge channel 132 extending substantially perpendicular to the axis of rotation R is preferably less than a cross-sectional flow section area of the infeed channel 114. It is also preferable that a cross-sectional flow area for the filtrate in the intermediate space 9 is greater than the cross-sectional area of the discharge channel 132. A flow resistance through the discharge channel 132 is thus preferably greater than a flow resistance in the intermediate space 9, whereby a separation effect can be reinforced.

The flexible discharge 122 and the flexible infeed 96 are particularly preferably disposed at opposite end faces of the strainer element 6. Particularly advantageous flow of the wastewater 3 can thereby be achieved. It can also be preferable, however, that an infeed and a discharge of the wastewater 3 take place on the same side of the strainer element 6.

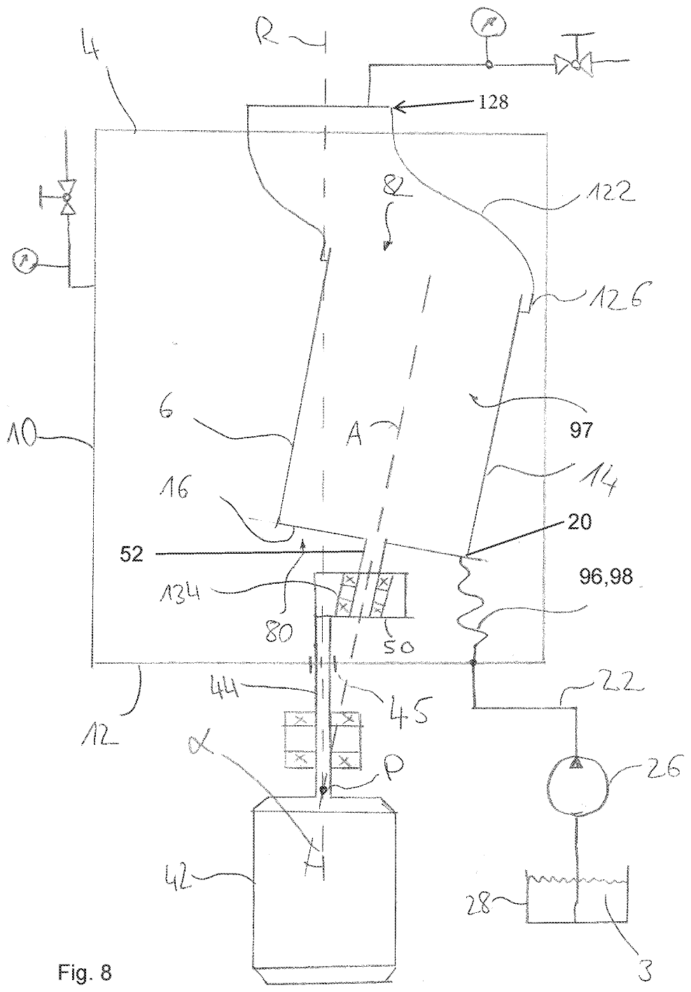

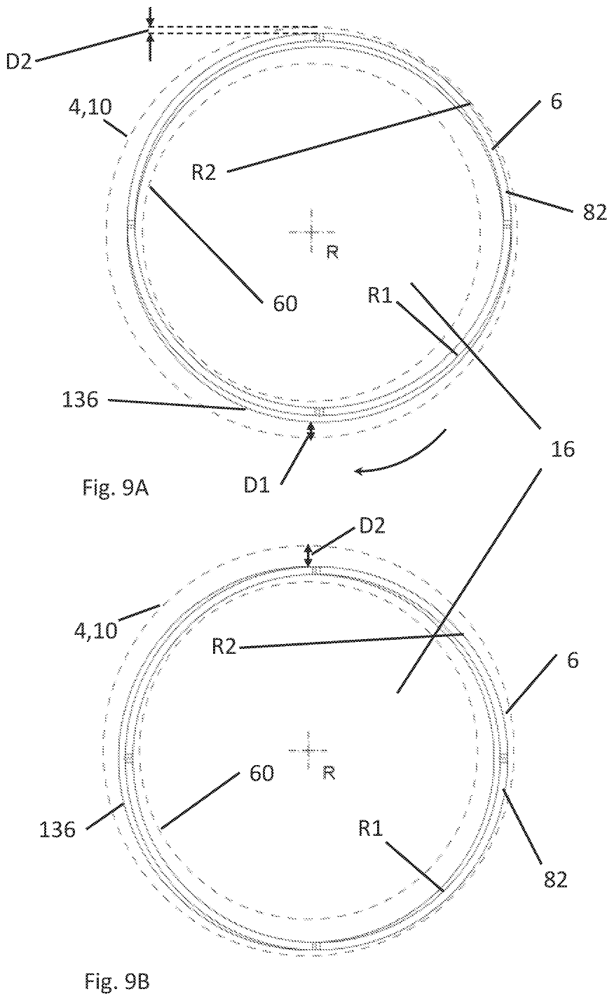

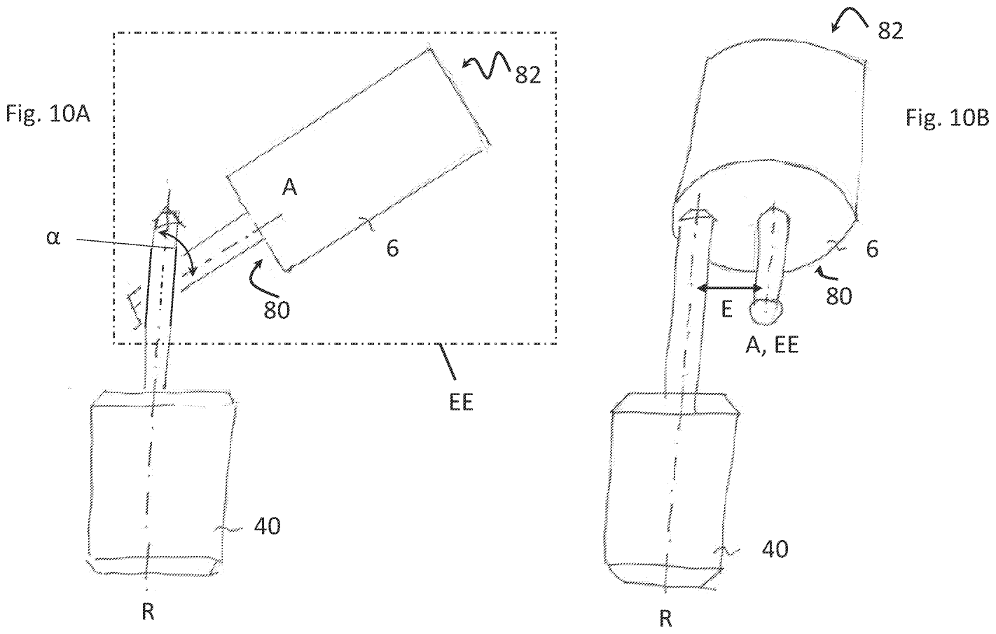

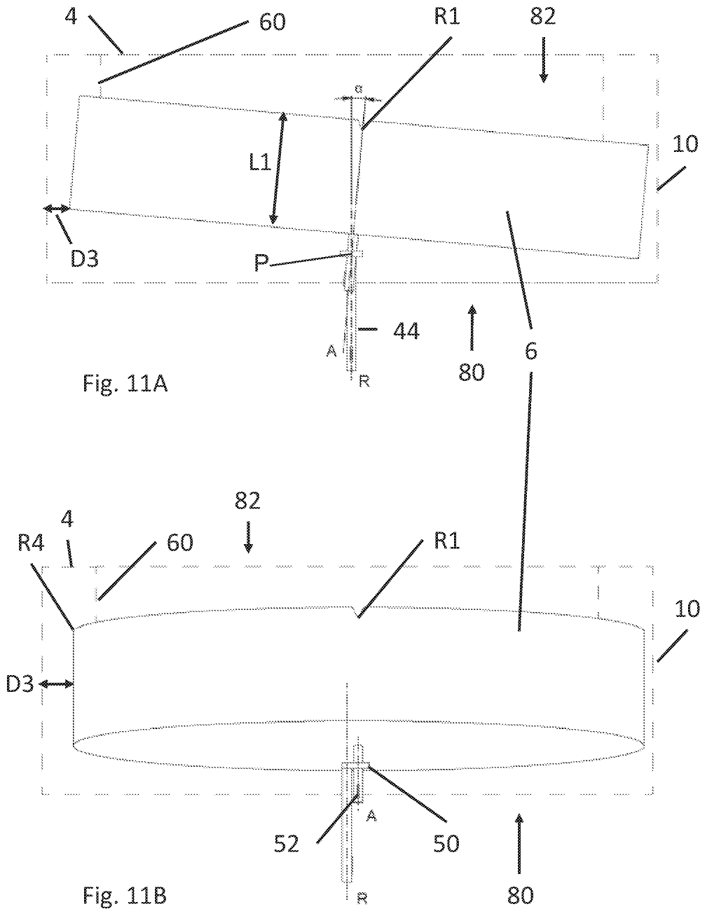

According to a fourth embodiment (FIG. 8), a fifth embodiment (FIGS. 9A, 9B, 11A, and 11B), and a sixth embodiment (FIGS. 10A, 10B), the central axis A of the strainer element 6 is inclined relative to the axis of rotation R. Identical and similar elements are in turn labeled with the same reference signs as were used in the first two embodiment examples. In this respect, full reference is made to the description above.

The strainer shaft 52 of the strainer element 6 is received in the eccentric 50 at an angle and is rotatably supported by means of an angled bearing 134 (FIG. 8). The central axis A of the strainer element 6 intersects the axis of rotation R at the point P and forms the angle of inclination a with the axis of rotation. The point P is preferably disposed proximal to the first end face 80 of the strainer element 6. It can also be preferable that the point P is disposed proximal to the second end face 82 of the strainer element 6. The point P is preferably outside the strainer element 6. It can also be preferable, however, that the point P is in the interior of the strainer element 6. A first end 126 of the flexible discharge 122 is completely sealingly connected to the strainer element 6 at the second end face 82. The flexible discharge 122 is thereby torsionally rigid in design and a second end 128 thereof is fixed to the housing 4, so that the strainer element 6 is rotationally fixed about the central axis A. If the eccentric 50 is driven by means of the drive shaft 44 and the electric motor 42, then the strainer element 6 is moved on a circular path about the axis of rotation R, wherein a rotation of the strainer element 6 about the central axis A is substantially prevented by the flexible discharge 122. The strainer element 6 performs a tumbling motion, wherein the inclined bearing 134 allows rotating of the strainer shaft 52 relative to the eccentric 50. The central axis A thereby describes a motion tracing a surface of a cone. It can also be preferable that the strainer shaft 52 is fixed to the eccentric 50, so that the central axis A traces the surface of a cylinder during the rotation about the axis of rotation R, the longitudinal axis thereof being inclined to the axis of rotation R.

The plan views of the separator device 1 according to the fifth embodiment shown in the FIGS. 9A and 9B depict the tumbling motion of the strainer element 6 when rotating about the central axis R. FIG. 9B shows a plan view of the separator device 1 analogous to the plan view shown in FIG. 9A, wherein the eccentric 50 has been rotated clockwise 90°. The press element 60 and the housing 4 are shown by dashed lines in FIGS. 9A and 9B. As the reference points R1 and R2 indicate, shown here only for clarifying the tumbling motion, the strainer element 6 is rotationally fixed relative to a central axis A. During the motion, the strainer element 6 retains the orientation thereof relative to the central axis A and is moved at least along a segment of a circular path. Here, the entire strainer element 6 is moved on a circular path. A first circumferential distance D1, measured between the side wall 10 of the housing and the strainer element 6 in the region of the base plate 16, the outer circumference thereof being depicted by the line 136, is varied just like a second circumferential distance D2, measured along a perpendicular line between the side wall 10 and the strainer element 6 in the region of the second end face 82. It can also be provided, however, that the base plate 16 is merely tilted during the motion of the eccentric 50, so that the first circumferential distance D1 is constant. It can further be provided that the first circumferential distance D1 is varied to a lesser extent than the second circumferential distance D2. In FIG. 9A, a minimum of the second circumferential distance D2 is disposed in the region of the reference point R2, wherein the minimum of the second circumferential distance D2 is at the reference point R1 in FIG. 9B. The first circumferential distance D1 is varied during the rotation of the strainer element 6 about the axis of rotation R. It can also be preferable that both the first circumferential distance D1 and the second circumferential distance D2 are varied, or that only the first circumferential distance D1 is varied while the second circumferential distance D2 is constant.

The flexible infeed 96 is implemented here as a first infeed hose 98 (FIG. 8). Wastewater 3 is transported through an inlet pipe 22 to the inlet 20 by means of the pump 26 and travels into the interior space 97 of the strainer element 6 by means of the flexible infeed 96 opening into the strainer element 6. The flexible infeed 96 can be implemented as a simple hose. Because the floor plate 16 is merely tilted during the rotation of the strainer element 6 about the axis of rotation R, the flexible infeed 96 can be effectively prevented from “winding up” on the eccentric 50 and/or the drive shaft 44. It should be understood that such “winding up” can also be prevented if the floor plate is moved on a circular path. For example, the drive shaft 44 and the eccentric 50 can extend through the flexible infeed 96. “Winding up” can also be prevented if the flexible infeed 96 is connected to the strainer element 6 outside of a trajectory of the eccentric 50 in the circumferential direction.

In a sixth embodiment of the invention, the central axis A of the strainer element 6 is inclined relative to the axis of rotation R. The central axis A of the strainer element 6 is thereby disposed in an eccentric plane EE spaced apart from the axis of rotation R by the eccentric distance E and parallel to the same. The central axis A of the strainer element 6 and the axis of rotation R are implemented skewed to each other and do not have a point of intersection (FIG. 10B). Here the angle of inclination a is determined by the projection of the central axis A onto the axis of rotation R (FIG. 10A). During operation, the eccentric plane EE is always parallel to the axis of rotation R and rotates about the same. In the present embodiment example, the strainer element 6 is moved on a circular path about the axis of rotation R by means of the drive 40. The first end face 80 thereby precedes the second end face 82. The view shown in FIG. 10B is thereby rotated by 270° relative to the view shown in FIG. 10A. It should be understood that further elements of the separator device are not shown in FIGS. 10A and 10B for reasons of clarity.

According to the fifth embodiment example, the axis of rotation R is parallel to the side wall 10 of the housing 4. The axis of rotation R can also preferably be inclined relative to the housing 4 (FIG. 11B). The strainer element 6 is connected to the drive shaft 44 of the drive 40 by means of the strainer shaft 52 and the eccentric 50. The strainer shaft 52 extends through the eccentric 50 and is rotatably supported relative to the same The central axis A of the strainer element 6 is inclined by the angle of inclination a relative to the axis of rotation R. A projection of the central axis A or the central axis A preferably intersects the axis of rotation R at the intersection point P, preferably in the eccentric 50. In a particularly preferred embodiment, the strainer shaft 52 is implemented as a hollow shaft supported on an eccentric lug 86. The intersection point P is preferably in the interior of the strainer element 6, preferably in a range from 30% to 70%, particularly preferably at 50%, of a length L1 of the strainer element 6 as measured between the first end face 80 and the second end face 82. The central axis A is also spaced apart from the axis of rotation R by the eccentric distance E (not shown in FIGS. 11A and 11B). The strainer shaft 52 opens into the strainer element 6 at the first end face 80 at a right angle. Embodiments having strainer shafts 52 opening into the strainer element 6 at an angle, however, are also preferable. Here a side wall 10 of the housing 4, indicated in FIGS. 11A and 11B by dashed lines, is vertically oriented. It should be understood that the separator device according to the fifth and sixth embodiments can comprise additional features according to the embodiments described above. In this respect, reference is made to the entire above description for individual features and the advantages thereof.

During operation, the strainer element 6 is moved on a circular path by means of the drive shaft 44, wherein the radius of the circular path corresponds to the eccentric distance E. During the circular path motion of the strainer element 6, said element rotates relative to the eccentric 50, so that an orientation of the strainer element 6 in the housing 4 remains substantially the same. A location of the reference point R1 is substantially constant, despite the circular path motion. It should be understood that the substantially constant location of the reference point R1 is relative to the orientation in the housing 4. The reference point R1 is not rotated about the central axis A here, but is moved along the circular path defined by the eccentric 50 and performs a relative lifting motion. An absolute value of a third circumferential wall distance D3, measured between the side wall 10 of the housing 4 and the strainer element wall 14, varies during operation due to the eccentric motion. The strainer element wall 14 of the strainer element 6 also performs a relative lifting motion, so that a relative minimum of the third circumferential wall distance D3 travels from the first end face 80 to the second end face 82 along a line on the strainer element wall 14 parallel to the central axis A. In FIG. 11A, the third circumferential wall distance D3 is variable, wherein said distance has a minimum value proximal to the first end face 80. If the eccentric is rotated further, a minimum valve of the third circumferential wall distance D3 travels continuously from the first end face 80 in the direction of the second end face 82. An absolute value of the third circumferential wall distance D3 thereby varies due to the motion of the strainer element 6 on the circular path. It should be understood that a second minimum of the third circumferential wall distance D3, disposed 180° offset from the first minimum, simultaneously travels form the second end face 82 to the first end face 80.

The relative lifting motion of the strainer element 6 is phase-shifted from the rotation of the strainer element 6 determined by the eccentric 50. It should be understood that the relative lifting motion may also be performed only partially by parts of the strainer element. The relative lifting motion preferably takes place in the region of the strainer element wall 14, wherein the relative height is constant at a centroid of the strainer element. Here the relative lifting motion lags the circular path motion by a value of approximately 90°. In FIG. 11A, the eccentric 50 extends out of the plane of the drawing, so that the central axis A is disposed in front of the axis of rotation R. The relative lifting motion is phase-shifted by approximately 90° and begins with a minimum value of the third circumferential wall distance D3 disposed proximally to the first end face 80. In FIG. 11B the eccentric faces to the right, wherein the relative lifting motion has taken on a middle position. The third circumneutral wall distance D3 is substantially constant between the first end face 80 and the second end face 82. In the present embodiment example, the relative lifting motion lags the circular path motion. Due to the relative lifting motion, fibrous material 2 and/or filtrate can be moved from the first end face 80 to the second end face 82. Embodiments are also preferable wherein the lifting motion runs in the opposite direction and/or the lifting motion precedes the circular path motion. A second lifting motion of the strainer element 6 relative to the press element 60 is phase-shifted by 180°. In FIG. 11B, a velocity of the relative lifting motion is at a maximum, wherein a maximum pressure simultaneously acts on the strainer element 6 at the reference point R4 due to the acceleration of the wastewater 3. A first acceleration at a reference point, caused by the motion of the strainer element 6 on the circular path, is preferably at a maximum when the strainer element 6 is oriented parallel to the side wall 10 of the housing 4 in the region of the reference point. Particularly efficient separation can thereby be achieved and/or clogging of the strainer element 6 can be prevented. Fibrous material 2 building up on the strainer element wall 14 is particularly preferably moved in the direction of the second outlet 36 by the tumbling motion, particularly preferably by the relative lifting motion.

1-56. (canceled)

57. A separator device for separating fibrous material from wastewater, comprising:
a housing comprising at least one inlet for wastewater, at least one first outlet for filtrate, and at least one second outlet for the fibrous material; and
at least one hollow strainer element disposed in the housing;
wherein the at least one inlet is in fluid communication with an interior of the at least one hollow strainer element and the first outlet is in fluid communication with an intermediate space between the housing and the at least one hollow strainer element; and
wherein the at least one hollow strainer element is movably arranged in the housing and coupled to a drive for displacing the at least one hollow strainer element.

58. The separator device according to claim 57, wherein the at least one hollow strainer element comprises a central axis.

59. The separator device according to claim 58, wherein the at least one hollow strainer element is moved at least along a segment perpendicular to the central axis during operation.

60. The separator device according to claim 58, wherein the at least one hollow strainer element is rotated about an axis of rotation at least along a segment during operation.

61. The separator device according to claim 58, wherein the at least one hollow strainer element is substantially rotationally fixed about the central axis.

62. The separator device according to claim 57, wherein the drive comprises an eccentric and wherein the at least one hollow strainer element is rotatably supported on the eccentric.

63. The separator device according to claim 58, wherein the central axis is oriented substantially vertically in operation.

64. The separator device according to claim 59, wherein the central axis of the at least one hollow strainer element is offset parallel to the axis of rotation by an eccentric distance.

65. The separator device according to claim 58, wherein the central axis of the at least one hollow strainer element is angled relative to the axis of rotation.

66. The separator device according to claim 65, wherein the at least one hollow strainer element performs a tumbling motion during operation.

67. The separator device according to claim 66, wherein the tumbling motion of the at least one hollow strainer element is a superimposed motion comprising a circular path motion and a relative lifting motion, wherein the circular path motion and the lifting motion are phase-shifted with respect to each other.

68. The separator device according to claim 67, wherein the phase shift between the circular path motion and the relative lifting motion has a value in a range from 5° to 180°.

69. The separator device according to claim 66, wherein the at least one hollow strainer element is coupled to the drive by means of a joint element.

70. The separator device according to claim 57, wherein the at least one hollow strainer element is substantially cylindrical.

71. The separator device according to claim 57, wherein the at least one hollow strainer element is substantially conical.

72. The separator device according to claim 57, wherein the drive comprises a motor and a drive shaft extending into the housing and coupled to the at least one strainer element for rotationally driving the at least one hollow strainer element.

73. The separator device according to claim 57, wherein a press device is provided within the at least one hollow strainer element and is adapted for changing a distance from a strainer element wall during operation for pressing fibrous material against the strainer element wall.

74. The separator device according to claim 73, wherein the press device comprises a bar-shaped or tube-shaped press element.

75. The separator device according to claim 73, wherein the press device comprises a conical press element.

76. The separator device according to claim 73, wherein the press element is freely movable within the at least one hollow strainer element.

77. The separator device according to claim 73, wherein the press element is guided or stationary within the at least one hollow strainer element.

78. The separator device according to claim 77, wherein the press element is fixed on a first side of the housing opposite the drive.

79. The separator device according to claim 73, wherein the press device comprises a bar-shaped or tube-shaped press element or a conical press element and wherein the press element extends along the axis of rotation.

80. The separator device according to claim 73, wherein the press device comprises a bar-shaped or tube-shaped press element or a conical press element and wherein the press element extends into the strainer element in a range from about 20% to 100% of a length of the at least one hollow strainer element, measured between a first end face of the at least one hollow strainer element disposed proximally to the drive, and a second end face of the at least one hollow strainer element opposite the first end face.

81. The separator device according to claim 57, wherein the at least one hollow strainer element preferably has a mesh size of 10 μm to 300 μm.

82. The separator device according to claim 57, wherein the at least one second outlet is connected to the at least one hollow strainer element by means of a flexible discharge.

83. The separator device according to claim 82, wherein the flexible discharge fixes the at least one hollow strainer element rotationally about a central axis.

84. The separator device according to claim 82, wherein the flexible discharge is connected to the at least one hollow strainer element in a fully sealed manner.

85. The separator device according to claim 82, wherein the flexible discharge is connected to a second end face of the at least one hollow strainer element opposite a first end face of the at least one hollow strainer element disposed proximally to the drive.

86. The separator device according to claim 82, wherein the flexible discharge comprises a discharge hose connected at a first end to the at least one hollow strainer element.

87. The separator device according to claim 86, wherein a second end of the discharge hose is connected to the housing for substantially rotationally fixing the at least one hollow strainer element.

88. The separator device according to claim 82, wherein a press element is provided within the at least one hollow strainer element and is adapted for changing a distance from a strainer element wall during operation for pressing fibrous material against the strainer element wall, and the press element is disposed at least partially within the flexible discharge and forms a discharge channel with the flexible discharge.

89. The separator device according to claim 57, wherein the at least one inlet is connected to the interior of the at least one hollow strainer element by a flexible infeed.

90. The separator device according to claim 89, wherein the flexible infeed is connected to the at least one hollow strainer element in a fully sealed manner.

91. The separator device according to claim 89, wherein the flexible infeed is connected to a first end face of the at least one hollow strainer element disposed proximally to the drive.

92. The separator device according to claim 91, wherein a drive shaft of the drive extends at least partially through the flexible infeed.

93. The separator device according to claim 89, wherein the flexible infeed comprises at least one infeed hose.

94. The separator device according to claim 93, wherein the flexible infeed comprises a first infeed hose and a second infeed hose, and wherein the second infeed hose extends at least partially within the first infeed hose for forming an infeed channel.

95. The separator device according to claim 94, wherein the first infeed hose is fully sealingly connected to a cylindrical surface of the at least one hollow strainer element, and wherein the second infeed hose is sealingly connected to a step of the at least one hollow strainer element.

96. The separator device according to claim 57, further comprising a feed pump for feeding the wastewater into the at least one hollow strainer element under pressure.

97. The separator device according to claim 96, wherein the at least one first outlet comprises a cut-off valve implemented for adjusting a first discharge pressure for the filtrate.

98. The separator device according to claim 97, wherein the at least one second outlet comprises a shut-off valve implemented for adjusting a second discharge pressure for the fibrous material.

99. The separator device according to claim 99, wherein the first discharge pressure is lower than the second discharge pressure.

100. The separator device according to claim 58, comprising an inlet pipe forming the inlet and extending into the interior of the at least one hollow strainer element substantially along the axis of rotation.

101. The separator device according to claim 100, further comprising a press device is provided within the at least one hollow strainer element and is adapted for changing a distance from a strainer element wall during operation for pressing fibrous material against the strainer element wall, wherein the press device comprises a press element and the inlet pipe forms the press element.

102. The separator device according to claim 57, wherein the drive comprises an oscillation gearbox for driving the at least one hollow strainer element in an oscillating manner.

103. The separator device according to claim 57, wherein at least two strainer elements are provided.

104. The separator device according to claim 103, wherein the at least two strainer elements are disposed so that an axis of rotation at least along a segment of at least two strainer elements is outside of the at least two strainer elements.

105. A method for separating fibrous material from wastewater, using a separator device comprising a housing comprising at least one inlet for wastewater, at least one first outlet for filtrate, and at least one second outlet for the fibrous material; and
at least one hollow strainer element disposed in the housing;
wherein the at least one inlet is in fluid communication with an interior of the at least one hollow strainer element and the first outlet is in fluid communication with an intermediate space between the housing and the at least one hollow strainer element; and
wherein the at least one hollow strainer element is movably arranged in the housing and coupled to a drive for displacing the at least one hollow strainer element, the method comprising the steps of:
feeding wastewater carrying fibers into the at least one hollow strainer element;
moving the at least one hollow strainer element;
filtering wastewater at the at least one hollow strainer element;
discharging filtrate out of an intermediate space between the at least one hollow strainer element and the housing; and
discharging fibrous material from the interior of the at least one hollow strainer element.

106. The method according to claim 105, wherein the at least one hollow strainer element comprises a central axis.

107. The method according to claim 106, wherein the moving step is performed at least in segments perpendicular to the central axis.

108. The method according to claim 105, wherein the moving step comprises a tumbling motion.

109. The method according to claim 105, wherein the moving step comprises oscillation.

110. The method according to claim 105, further comprising the steps of:
filtering the wastewater at a first segment of the at least one hollow strainer element trailing with respect to a direction of motion; and
backflushing the at least one hollow strainer element in a second segment of the at least one hollow strainer element leading with respect to a direction of motion.

111. The method according to claim 105, further comprising the step of:
pressing fibrous material by a press element against an inner side of a strainer element wall of the at least one hollow strainer element.

112. The method according to claim 105, wherein the at least one hollow strainer element is rotationally fixed about a central axis.
